(19) United States
(12) Patent Application Publication
(10) Pub. No.: US 2007/0038532 A1
(43) Pub. Date: Feb. 15, 2007

(54) Method and system for integrated service delivery

(75) Inventor: Bhavin J. Vyas, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/201,137

(22) Filed: Aug. 11, 2005

(51) Int. Cl. G06F 17/00

(52) U.S. Cl. 705/28

(57) ABSTRACT

A method for managing a plurality of machines may include producing a service recommendation based on status information related to the machines, and automatically generating an electronic service order for the service recommendation. The method may also include sending the electronic service order to an entity to fulfill the electronic service order.

### TECHNICAL FIELD

The present disclosure relates to a delivery method and system, and more particularly, to a method and system for integrated service delivery.

### BACKGROUND

The management of equipment, such as, for example, a fleet of machines, may be a time consuming and difficult task. Equipment management may involve gathering equipment data, managing and interpreting the data, and scheduling/performing machine maintenance in response to the data. Performing maintenance and coordinating all of the activity surrounding or going into the maintenance of a single machine may be difficult for complex machines having many components, and the difficulty may be compounded when multiple machines are involved.

Presently, there are systems designed to manage a plurality of machines. One such system is disclosed in U.S. Patent Application Publication No. 2004/0073468 to Vyas et al. (“the '468 publication”). The '468 publication describes a fleet management system used to manage a plurality of machines. The fleet management system includes a communication conduit coupled to the machines for receiving status information related to the machines and a repository coupled to the communication conduit for receiving and storing the status information. The system also includes a fleet manager controller coupled to the repository for analyzing the status information. The fleet management system is adapted to automatically order parts for maintenance and/or check inventory levels and order parts if inventory levels fall below a predetermined level. Additionally, if the part is in inventory, the system reserves the part so that it will be available when maintenance is performed.

Thus, the system in the '468 publication may provide integration to a parts ordering system, and additionally, may also schedule equipment transportation and maintenance. However, the system in the '468 publication may not automatically provide for delivery of those services needed to install the parts and perform the scheduled maintenance. Furthermore, the system may not have the ability to integrate and automate billing activities upon completion of those services.

The system of the present disclosure is directed towards overcoming one or more of the constraints set forth above.

### SUMMARY OF THE INVENTION

In one aspect, the present disclosure may be directed to a method for managing a plurality of machines. The method may include producing a service recommendation based on status information related to the machines, and automatically generating an electronic service order for the service recommendation. The method may also include sending the electronic service order to an entity to fulfill the electronic service order.

In another aspect, the present disclosure may be directed to a computer readable medium for use with a computer system. The computer readable medium may include computer executable instructions for performing a method. The method may include producing a service recommendation based on status information related to machines, and automatically generating an electronic service order for the service recommendation. The method may also include sending the electronic service order to an entity to fulfill the electronic service order.

In yet another aspect, the present disclosure may be directed to a management system configured to manage a plurality of machines for a customer. The management system may include a fleet management system configured to automatically deliver services. The management system may also include a customer business system configured to communicate with the fleet management system, and a supplier business system configured to communicate with the fleet management system.

### BRIEF DESCRIPTION OF THE DRAWINGS

FIG. 1 is a diagrammatic illustration of an integrated business system, according to an exemplary disclosed embodiment.

FIG. 2 is a diagrammatic illustration of an fleet management system, according to an exemplary disclosed embodiment.

FIG. 3 is a flow diagram of a method, according to an exemplary disclosed embodiment.

### DETAILED DESCRIPTION

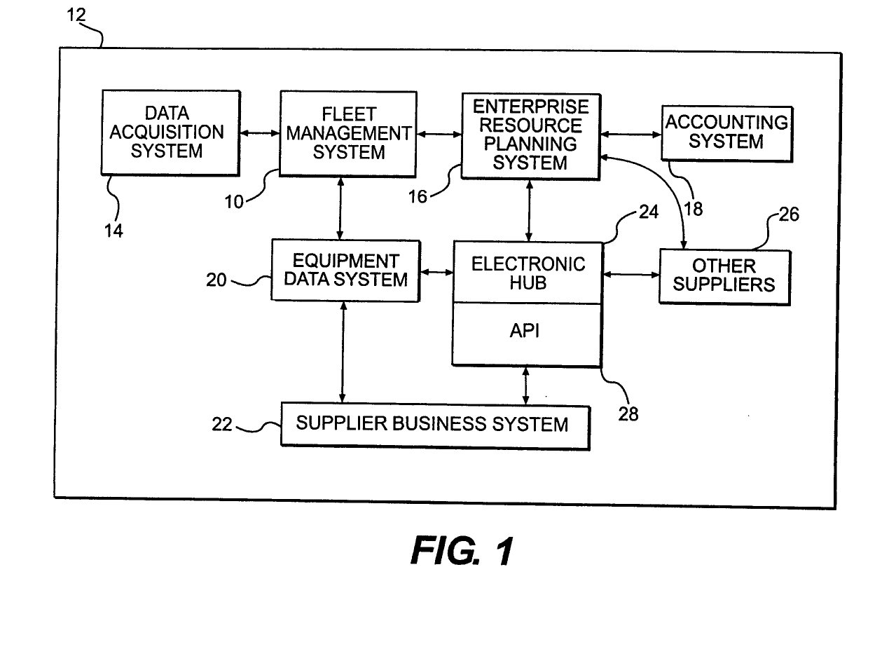

FIG. 1 illustrates an exemplary disclosed integrated business system 12. Integrated business system 12 may integrate information, hardware, software applications, and business functions in a customer's business. In an exemplary disclosed embodiment, integrated business system 12 may include a fleet management system 10, a data acquisition system 14, an enterprise resource planning (ERP) system 16, an accounting system 18, an equipment data system 20, a supplier business system 22, an electronic hub 24, and an application programmer interface (API) 28. Each of the sub-components may include a variety of configurations to suit particular applications, and integrated business system 12 is not limited to any particular configuration of these sub-components.

Data acquisition system 14 may monitor equipment and provide equipment updates. For example, data acquisition system 14 may record and compile machine information, including health and performance data, that may be transmitted to fleet management system 10. Data acquisition system 14 may include hardware and software components configured to sense and collect data from machines 30, and/or receive information from off-site machine data resources.

Enterprise resource planning (ERP) system 16 may include hardware and software configured to integrate and automate business operations. Enterprise resource planning system 16 may provide for asset registration, work-order planning/scheduling, resource scheduling, parts inventory, parts procurement, cost tracking, and other enterprise resource planning features. Enterprise resource planning system 16 may further include an outward business-to-business connector allowing the customer's enterprise resource planning system 16 to connect to business systems of other suppliers 22 and 26.

Accounting system 18 may include software for core accounting, business intelligence tools, human resources and payroll, customer relationship management, and financial reporting software. Accounting system 18 may be in communication with enterprise resource planning system 16 and may keep track of financial data and transactions. Various conventional accounting systems are known, and it is contemplated that any of such systems may be used in the presently disclosed embodiments. It is also contemplated that accounting system 18 may be included in enterprise resource planning system 16.

Equipment data system 20 may store a list of all of the equipment in a fleet, an inventory of machine information and manage asset (machine) registration between fleet management system 10, enterprise resource planning system 16, and supplier business system 22. Equipment data system 20 may include one or more databases, processors, input devices, output devices, and networking interfaces. For example, equipment data system 20 may include a personal computer, mainframe, or server. Equipment data system 20 may also include computer executable code and software configured to perform the aforementioned functions.

Supplier business system 22 may perform the function of managing a business relationship between the customer and a supplier. As used herein, the term “supplier” is intended to broadly encompass an entity associated with providing a machine or servicing of the machine, such as, for example, dealers, technicians within the customer's organization, and third party suppliers/service providers. Supplier business system 22 may communicate with a plurality of components within the customer's integrated business system 12. For example, supplier business system 22 may transmit/receive data to/from equipment data system 20, electronic hub 24, and/or application programmer interface 28. Additionally, other suppliers 26 may each include their own supplier business systems 22 and each may communicate with components of integrated business system 12.

Other components of integrated business system 12 may include electronic hub 24 and application programmer interface (API) 28. These elements may be configured to manage integrated procurement processes. Electronic hub 24 and application programmer interface 28 may be in communication with equipment data system 20, one or more supplier business systems 22, enterprise resource planning system 16, and other suppliers 26. Each of these elements may include one or more databases, processors, input devices, output devices, and networking interfaces, which may be configured to perform the aforementioned functions. Additionally, electronic hub 24 may act as a communication conduit to transmit and receive information to and from a customer business system 38, supplier business system 22, and fleet management system 10.

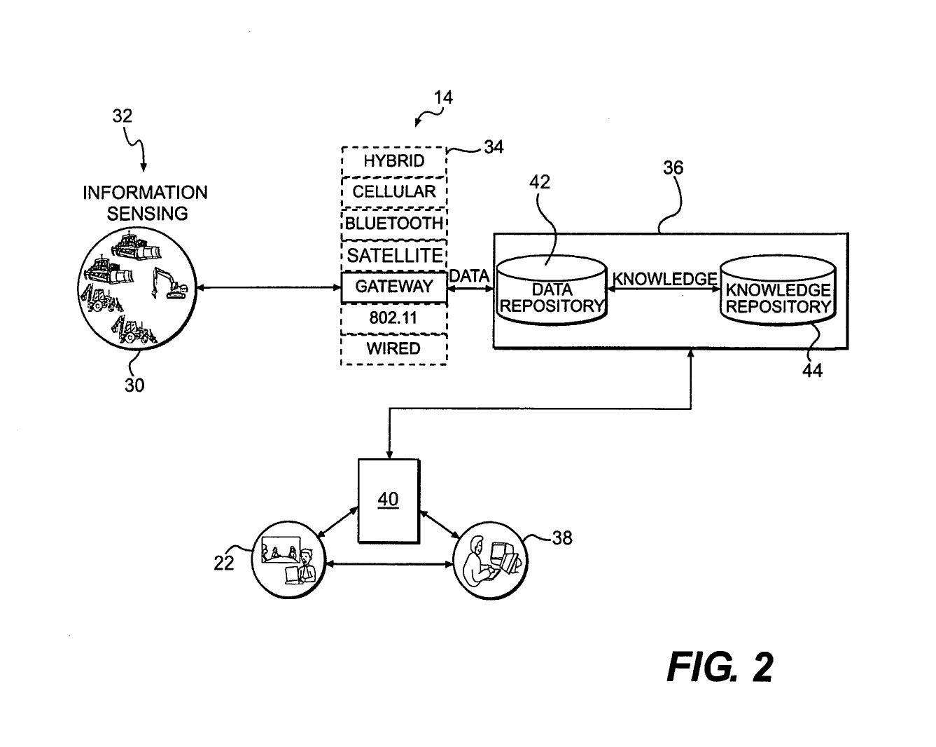

With reference to FIG. 2, an example of data acquisition system 14 is shown. Data acquisition system 14 may perform the function of tracking and managing information regarding a plurality of assets, such as, for example, machines 30. Within integrated business system 12, data acquisition system 14 may provide for, among other things, time based maintenance, condition based maintenance, preventative maintenance (scheduling and tracking), parts tracking, and parts ordering. It is contemplated that data acquisition system 14 may be utilized with a number of different types of mobile and non-mobile machines (assets), including, for example, engines, automobiles, and construction, agricultural, or earthmoving equipment. Elements of data acquisition system 14 may include an information sensing system 32, a communication conduit 34, and a repository 36. Information within data acquisition system 14 may be supplied to fleet management system 10, and then to customer business system 38 and supplier business system 22. Each of the sub-components described above may include a variety of configurations to suit a particular application.

Information sensing system 32 may include on-board and off-board hardware and software, including data acquisition, analysis, storage, and display systems for machines 30 and other assets. Information sensing system hardware may include, for example, sensors and/or an on-board controller (not shown) to monitor and derive machine component information and make such information available to fleet management system 10. While one embodiment of information sensing system 32 is described, it is contemplated that any other architectures or schemes suitable for collecting and calculating parameter information may also be used.

Communication conduit 34 may be operatively coupled to assets, which may include machines 30, for sending and/or receiving machine status information. Communication conduit 34 may include one or a combination (hybrid) of one or more of the following: satellite data link, cellular telephone communications link, radio link, bluetooth, 802.11, a wired communications link, or any other suitable communications datalink. Communication conduit 34 for a particular system may be selected based upon the nature of machines 30 and the environment in which machines 30 operate.

Information gathered from machines 30, may be transmitted to repository 36. Repository 36 may receive and store information related to machines 30, such as product watch data, fault code data, scheduled oil sample data, service meter hours, fuel data, and location information, repair history data, utilization data, preventative maintenance data, and performance data. Repository 36 may include a computer database or some other suitable electronic storage device. In one embodiment, repository 36 may include a data repository 42 and a knowledge repository 44. Knowledge related to machines 30 may be stored in knowledge repository 44, e.g., machine specific information such as product maintenance schedules for machines 30. Data repository 42 and knowledge repository 44 may be implemented as separate repositories or, alternatively, as a single combined unit.

Fleet management system 10 may include a fleet management controller 40 coupled to repository 36 for analyzing the machine status information. Fleet management controller 40 may include, for example, a computer running one or more software applications. Additionally or alternatively, fleet management controller 40 may be implemented on one or more computers connected to a network, such as the Internet. Different users at different locations may have varying needs to access fleet management controller 40, and thus, it may provide different levels of access or functionality at different locations.

Fleet management controller 40 may be configured to generate electronic service orders based upon data from information sensing system 32. Additionally, fleet management controller 40 may receive electronic invoices upon fulfillment of the electronic service orders. Electronic service orders may contain service data, such as, for example, machine identifiers, supplier identifiers, service descriptions, labor and parts requirements, and dates and times. Electronic service orders may be created in a format similar to extensible markup language (XML) and electronic data interchange (EDI), which may be recognized and processed by dissimilar electronic business systems. It is further contemplated that electronic service orders may be similar in format to purchase orders for parts, as many business systems use standard electronic purchase orders for business-to-business transactions. Electronic invoices may contain similar data, such as, for example, machine identifiers, supplier/service provider identifiers, service descriptions, labor and parts requirements, cost of service, and dates and times. Electronic invoices may be created in industry standard format, similar to XML and EDI, which may be recognized and processed by dissimilar electronic systems. It is further contemplated that electronic invoices for services may be similar in format to electronic invoices for parts, as many business systems use standard electronic invoices for business-to-business transactions involving parts sales.

Fleet management controller 40 may be accessible to the customer and the supplier through customer business system 38 and supplier business system 22, respectively. The following description of customer business system 38 may also pertain to supplier business system 22. Customer business system 38 may include input devices (keyboard, mouse, touch screen, etc.); output devices (monitor, printer, audio speaker, etc.); and computer processors (not individually shown). Customer business system 38 may communicate with fleet management controller 40 through satellite data link, cellular telephone communications link, radio link, bluetooth, 802.11, a wired communications link, or any other suitable communications datalink. It is contemplated that customer business system 38 may include one or more personal computers, mainframes, laptops, personal digital assistants, cellular phones, and pagers. Each customer and supplier may have a customer business system 38 and supplier business system 22, respectively. It should be understood that data generated and/or communicated by and between the customer, supplier, and fleet management controller 40, may actually refer to data generated and/or transmitted by and between customer business system 38, supplier business system 22, and fleet management controller 40. Furthermore, the communicated data may be carried through a suitable communication conduit, such as electronic hub 24.

### INDUSTRIAL APPLICABILITY

The presently disclosed embodiments may provide a method and system for managing machines 30. The presently disclosed embodiments may also provide a method and system for integrated service delivery from entities to customers.

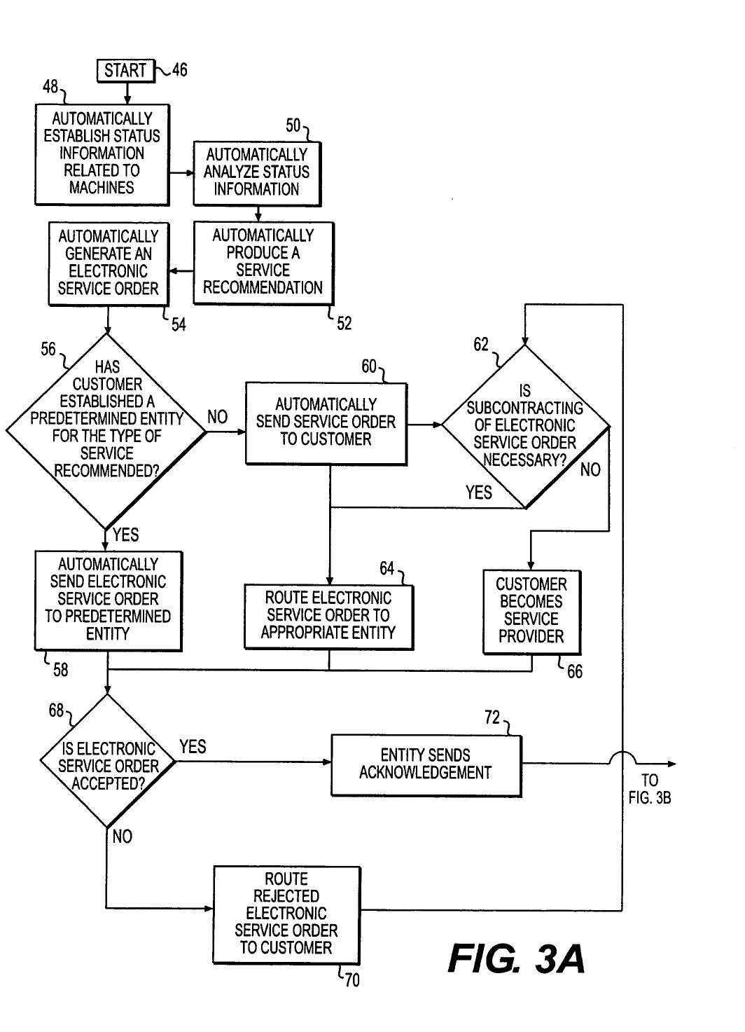

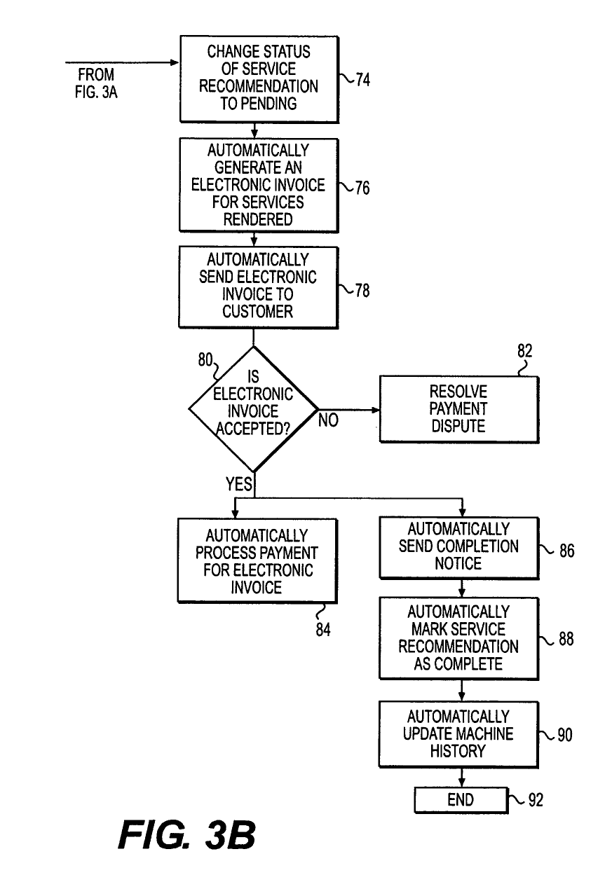

In one aspect of the presently disclosed embodiments, and as illustrated in FIGS. 3A and 3B, a method for integrated service delivery may be provided. As shown in FIG. 3A, the process may begin (step 46) by establishing machine status information (step 48) for a customer's machine or fleet of machines, and then automatically analyzing the machine status information (step 50). These steps may be executed by a fleet management controller 40 using data collected from a data acquisition system 14. From the analysis, fleet management controller 40 may automatically produce a service recommendation that may include a tentative date at which the service should be performed (step 52). The service recommendation may be based on, for example, predetermined asset/machine maintenance schedules, machine health, and/or machine performance.

Production of the service recommendation may automatically trigger fleet management controller 40 to generate an electronic service order (step 54). Fleet management controller 40 may determine whether the customer has established a predetermined entity, such as a preferred service provider, to provide the type of service being recommended (step 56). If a predetermined entity has been established, fleet management controller 40 may send the electronic service order to the predetermined entity (step 58). If, however, a predetermined entity has not been established, then fleet management controller 40 may automatically send the electronic service order to the customer (step 60). Upon receiving the electronic service order, the customer may choose whether to subcontract the electronic service order to an entity, such as a third-party provider, or utilize the customer's own service provider (step 62). If the customer selects a third-party entity to carry out the electronic service order, then the electronic service order may be routed to that entity (step 64). Alternatively, the customer may also choose to use its own service providers (step 66).

Once the electronic service order is routed to the entity, the next step may involve determining whether that entity accepts the electronic service order (step 68). It should be understood that the term “entity” hereinafter may include a predetermined entity, a non-predetermined entity, or the customer's own service provider. If the electronic service order is not accepted (rejected) by the entity, the entity may route the electronic service order to the customer (step 70), at which point the customer may elect to choose another entity or carry out service on its own (step 62). Alternatively, if the electronic service order is accepted by the entity (step 68), the entity may send a form of acknowledgement to fleet management controller 40 that may include a tentative date for performance of the service (step 72).

As shown in FIG. 3B, the acknowledgement may be received by fleet management controller 40 (step 74). Fleet management controller 40 may change the status of the service recommendation to “pending” to indicate that the service has been accepted by the entity but not yet performed (step 74). Upon performance of the service, the entity may automatically generate an electronic invoice for the services rendered (step 76). This electronic invoice may be automatically sent to the customer (step 78). The customer may determine whether to accept the electronic invoice or reject it (step 80). Rejection of the electronic service order may result in the customer and entity resolving a dispute over the payment (step 82). Alternatively, acceptance of the electronic service order may trigger automatic payment to fulfill the electronic invoice (step 84) and automatic sending of a completion notice to fleet management controller 40 (step 86). Upon receiving the completion notice, fleet management controller 40 may record the service recommendation as complete (step 88) and update the machine history accordingly (step 90). The method for the service recommendation may end at this point (step 92), but it should be understood that new service recommendations may be generated frequently, with each new service recommendation proceeding through the method from start (step 46).

The presently disclosed method and system may have several advantages. For example, fleet management system 10 may be incorporated into an existing integrated business system 12 framework, such as those used to provide integrated procurement for parts. Fleet management system 10 may build upon integrated procurement for parts by automatically providing for delivery of services needed to install the parts and perform the scheduled maintenance. Furthermore, fleet management system 10 may integrate and automate billing activities upon completion of those services. By utilizing fleet management system 10, service needs may be addressed 24 hours a day, 7 days a week, and 365 days a year. Thus, fleet management system 10 may ensure proper and timely maintenance of machines 30. This may result in prolonged machine life and may help avoid catastrophic failures. Efficiency may be improved by reducing the labor required to monitor and schedule maintenance and by decreasing the downtime of machines 30. Finally, the costs associated with fleet management may be reduced significantly.

It will be apparent to those skilled in the art that various modifications and variations can be made in the disclosed method and system without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A method for managing a plurality of machines, comprising:
producing a service recommendation based on status information related to the machines;
automatically generating an electronic service order for the service recommendation; and
sending the electronic service order to an entity to fulfill the electronic service order.

2. The method of claim 1, wherein the entity is a predetermined entity.

3. The method of claim 2, further including automatically sending the electronic service order to the predetermined entity.

4. The method of claim 1, further including automatically generating an electronic invoice for the fulfilled electronic service order.

5. The method of claim 4, further automatically including sending the electronic invoice to a customer.

6. The method of claim 5, further including automatically recording the service recommendation as completed upon acceptance of the electronic invoice.

7. The method of claim 1, further including automatically detecting fulfillment of the electronic service order.

8. A computer readable medium for use with a computer system, the computer readable medium having computer executable instructions for performing a method comprising:
producing a service recommendation based on status information related to machines;
automatically generating an electronic service order for the service recommendation; and
sending the electronic service order to an entity to fulfill the electronic service order.

9. The computer readable medium of claim 8, wherein the entity is a predetermined entity.

10. The computer readable medium of claim 9, wherein the method further includes automatically sending the electronic service order to the predetermined entity.

11. The computer readable medium of claim 10, wherein the method further includes automatically generating an electronic invoice for the fulfilled electronic service order.

12. The computer readable medium of claim 11, wherein the method further includes automatically sending the electronic invoice to a customer.

13. The computer readable medium of claim 12, wherein the method further includes automatically recording the service recommendation as completed upon acceptance of the electronic invoice.

14. The computer readable medium of claim 8, wherein the method further includes automatically detecting fulfillment of the electronic service order.

15. A management system configured to manage a plurality of machines for a customer, comprising:
a fleet management system configured to automatically deliver services;
a customer business system configured to communicate with the fleet management system; and
a supplier business system configured to communicate with the fleet management system.

16. The management system of claim 15, further including:
an information sensing system operatively coupled to the plurality of machines; and
a repository in communication with the information sensing system and accessible by the fleet management system.

17. The management system of claim 15, wherein the fleet management system is further configured to:
establish status information related to the machines;
analyze the status information; and
produce a service recommendation corresponding to the analysis.

18. The management system of claim 17, wherein the fleet management system is further configured to:
automatically generate an electronic service order based on the service recommendation; and
send the electronic service order to an entity to fulfill the electronic service order.

19. The management system of claim 18, wherein the fleet management system is further configured to:
automatically detect fulfillment of the electronic service order; and
automatically generate an electronic invoice upon fulfillment of the electronic service order.

20. The management system of claim 19, wherein the fleet management system is further configured to automatically record the service recommendation as completed upon acceptance of the electronic invoice.
